(19) United States
(12) Patent Application Publication
(10) Pub. No.: US 2014/0039970 A1
(43) Pub. Date: Feb. 6, 2014

(54) SYSTEMS AND METHODS FOR IDENTIFYING AND RELATING ASSET-TIED TRANSACTIONS

(71) Applicants: Mohammed N. Faridy, Mississauga (CA); Shahzad Chaudhri, Falls Church, VA (US)

(72) Inventors: Mohammed N. Faridy, Mississauga (CA); Shahzad Chaudhri, Falls Church, VA (US)

(21) Appl. No.: 13/567,087

(22) Filed: Aug. 5, 2012

(51) Int. Cl. G06Q 10/06

(52) U.S. Cl. CPC G06Q 10/0633
USPC 705/7.27

(57) ABSTRACT

Systems and methods for tracking assets are disclosed, where such assets' data exists in disparate and independent asset data sources within and throughout an organization. Assets' data is first assembled and processed, related between asset data sources and to particular assets, and stored in a processed format that allows reporting and monitoring.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Multiple corporate divisions and systems are involved in purchasing, tracking, maintaining, and using, corporate assets. For example, procurement divisions are typically involved in sourcing assets. Legal departments are involved in negotiating the detailed terms and conditions surrounding the purchase and maintenance of assets. Finance departments are typically involved in approving and documenting the financial aspects of purchasing the assets. IT departments are typically involved in deploying and tracking assets purchased.

Each of these divisions typically use different systems to perform their asset-tied tasks or workflows. While there may be some overlap (ie a department using one or more systems), they are often fairly separate and distinct.

Unfortunately these systems typically operate independently, resulting in significant inefficiencies and deficiencies in workflows.

Accordingly, the present invention provides systems and methods for identifying and relating asset-tied transactions.

### SUMMARY OF THE INVENTION

In one embodiment there is a method for monitoring assets throughout an organization, where data relating to such assets are stored and processed in disparate asset data sources, including a primary asset data source having one or more primary asset datasets, each primary asset dataset relating to an asset and containing primary asset data elements about the asset to which they relate, and one or more secondary asset data sources, each having one or more secondary asset datasets, each secondary asset dataset relating to an asset and containing secondary asset data elements about the asset to which they relate, the method may comprise receiving, by an asset tracking module on a processor, the one or more primary asset datasets from a primary asset data source, for each secondary asset data source and each secondary asset dataset therein: obtaining, by an asset tracking module on a processor, a secondary asset dataset from the secondary asset data source, relating, by an asset tracking module on a processor, the secondary asset dataset to one of the one or more primary asset datasets, processing, by an asset tracking module on a processor, the one or more primary datasets and the related secondary datasets into processed asset datasets, storing, by an asset tracking module on a processor into a database on a computer readable medium, the processed asset datasets, and tracking, by an asset tracking module on a processor, the assets using the processed asset datasets.

The relating may further comprise comparing, by an asset tracking module on a processor, one or more secondary asset data elements from the secondary asset dataset to one or more primary asset data elements from each of the fetched primary asset datasets, and matching, by an asset tracking module on a processor, the secondary asset dataset to a primary asset dataset if the compared data elements correspond. The appropriate compared data elements may comprise the vendor, and asset identifier and/or an asset description, asset deployment date and asset location. The processed asset datasets may comprise the compared data elements and at least one other primary asset data element and at least one other secondary asset data element. The primary asset data elements may contain at least one data element not found in any secondary asset data elements and each secondary asset data element may contain at least one data element not found in the primary asset data elements. The primary asset data source may comprise a contract management system and the one or more secondary asset data sources may comprise an asset management system.

The tracking may further comprise: receiving, by an asset tracking module on a processor, a request for processed asset datasets relating to a vendor, querying, by an asset tracking module on a processor to the computer readable medium containing the database, the processed asset datasets relating to the vendor, and providing, by an asset tracking module on a processor, the queried data results.

The queried data results may comprise the contracts with the vendor, the assets purchased from the vendor, and the total amount paid to the vendor.

There is further a system for tracking assets within an enterprise, where data relating to such assets are stored and processed in disparate asset data sources, the system comprising an asset tracker comprising a processor, a fetcher configured to communicate with one or more asset data sources and to receive one or more source data elements from each of the one or more asset data sources, a database on a computer readable medium with one or more sink data elements of processed data, and one or more data filters configured to receive the one or more source data elements from the fetcher, match the source data elements from the one or more asset data sources that relate to the same asset, process the related data into processed data and insert the processed data into the database.

The system may further comprise an application server, configured to receive requests to view the processed data, query the database to retrieve the request processed data, and provide the requested processed data. The system may further comprise one or more data sources, each having asset data comprising one or more source data elements, configured to communicate with the fetcher.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a diagram of a system for identifying and relating asset-tied transactions according to a non-limiting embodiment of the present invention;

FIG. 2 is a diagram of aspects of data structures and elements for asset-tied transactions according to a non-limiting embodiment of the present invention;

FIG. 3 is a flowchart depicting a method for inserting asset data according to a non-limiting embodiment of the present invention;

FIG. 4 is a flowchart depicting a further method for inserting asset data according to a non-limiting embodiment of the present invention;

FIGS. 5-7 are flowcharts depicting methods for using asset tracker according to non-limiting embodiments of the present invention; and

FIG. 8 is a diagram of user interface sequences for a system for identifying and relating asset-tied transactions according to a non-limiting embodiment of the present invention.

### DETAILED DESCRIPTION OF THE INVENTION

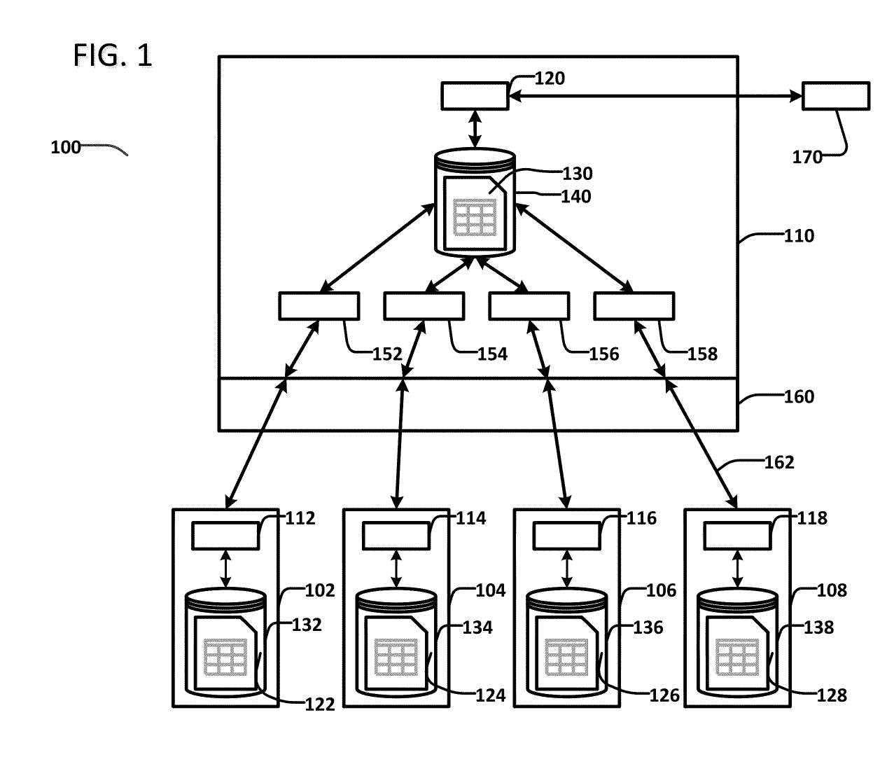

FIG. 1 is a diagram of system 100 for identifying and relating asset-tied transactions comprising asset tracker 110 (which may also be known as a data consolidator 110), communication paths 162, user computing device (UCD) 170, and asset data sources 102/104/106/108. Asset tracker 110 further comprises fetcher 160, data filters 152/154/156/158, asset tracker database 140 having one or more tables 130, and asset tracker application server 120. Asset data sources 102/104/106/108 further comprise processors 112/114/116/118, asset data databases 132/134/136/138 and asset tables 122/124/126/128.

It will be appreciated herein that several references are, at a high-level, fairly similar. For example, data filters 152/154/156/158, asset data sources 102/104/106/108, processors 112/114/116/118, etc may be substantially similar at a high-level and thought of as being in the same “reference family”. As used throughout, references to a particular member of a reference family reference are applicable to other members unless described as being applicable to only one member of that family.

It will further be appreciated that the systems, and elements thereof, described herein (such as asset data sources 102 and asset tracker 110) may be implemented using one or more computer apparatuses. Each of those computer apparatuses may have one or more computer readable media (such as RAM, ROM, hard drives or the like, as would be known in the art but are not shown herein) that may store a plurality of programming instructions, said programming instructions executable by the computing apparatus, such as by one or more processors, and able to communicate with the computer readable media including databases and tables as described herein.

Asset tracker 110 and asset data sources 102 may be implemented on one or more computer apparatuses (such as servers), having one or more processors capable of performing programming instructions, and one or more memory components or machine readable media capable of storing programming instructions. They may share any of these resources or may be on disparate physical systems and run independently. The components of asset tracker 110 and asset data sources 102 are also shown as being separate but may be implemented together and/or on the same physical systems while remaining within the scope of the present invention. Although the physical systems and implementation details may be important for the efficient operation of aspects of the present invention, there are many ways to implement aspects of the present invention (both in terms of software and hardware).

Communication paths 162 facilitate communication between any aspects of system 100. They may depend largely on the software and hardware implementation of system 100. Communication paths may include Internet, intranet, networked, wireless, near-field communication, sockets, client-server, and substantially any other type of communication path—either physical or virtual. It is to be understood that many ways to facilitate communication within and between aspects of system 100 are contemplated to be within the scope of the present invention.

Asset data sources 102 may be substantially any data source that has data related to assets that are to be tracked. Asset data sources 102 may provide various computer-implemented means to interact with them, and extract asset data from them.

Asset data sources may be, for example, purchase requisition system 102, contract management system 104, asset management system 106 and enterprise resource planning system 108, or any other system storing or using data related to assets, as described herein. Of course it is to be understood that any of these may be combined, and any number of other asset data sources may be employed and integrated according to aspects of the present invention. It is also to be understood that asset data sources 102 may often be independent asset data sources and therefore not interoperable or able to communicate between themselves. Each asset data source 102 may store its own data, in its own format, and that may also be different from any other data source's approach.

Each asset data source may be considered either a primary or secondary asset data source. In one embodiment, each system 100 may have one primary and one or more secondary asset data sources. The primary asset data source may be used as a starting point for relating data, for a given asset, from the one or more asset data sources. Contract management system 104 may be the primary asset data source, for example. This may be desirable as it may be the most reliable source for determining what assets are validly owned and may facilitate the matching or relating described herein. Of course other asset data sources may made primary and such embodiments would be considered within the scope of the present invention.

Purchase requisition (PR) system 102 may collect data from internal business units (such as requestor name and phone number, product name, part or asset number, part or asset description, price, approval workflow, and the like) in order to facilitate the acquisition of goods and services. Examples PR systems 102 are Oracle iProcure™, SAP SRM™ and Ariba iBuy™

Contract management (CM) system 104 may be a repository of legal documents in various electronic formats (MS Word™, PDF™, TIFF™, GIFF™, etc.) Examples of CR systems 104 are Docushare™, Cobblestone™ and Capterra™

Asset management (AM) system 106 may manage the deployment, utilization, maintenance and disposal of assets within an organization. Examples of AM Systems are Microsoft SMS™, IBM Tivoli™ and HP Openview™

Enterprise resource planning (ERP) system 108 may track an organization's spend data (purchase orders, invoices, receipts, etc.) from acquisition through to payment for goods and services. Exemplary ERP systems are Oracle e-Business Suite™, SAP ERP™ and Microsoft Dynamics™.

Processors 112/114/116/118, along with asset data databases 132/134/136/138 and asset tables 122/124/126/128, may allow asset data sources to function as described herein and may be substantially as would be known in those fields. It is to be understood that each asset data database 132/134/136/138 may comprise one or more databases (which may be denoted as “132A”, “132B”, etc) and each of the one or more databases of asset data database 132/134/136/138 may comprise one or more asset tables 122/124/126/128 (which may be denoted as “122A”, “122B”, etc).

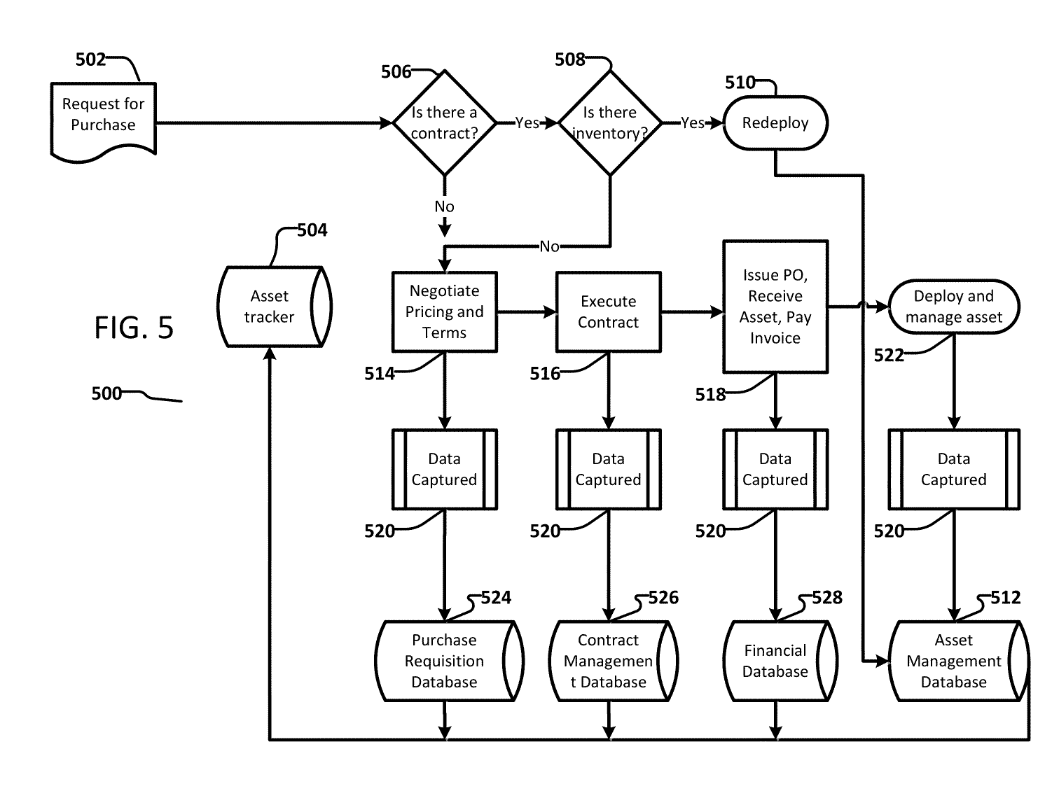

Asset tracker 110 retrieves or extracts asset data from asset data sources 102 (such data occasionally being referred to herein as client asset data), relates, processes and formats the extracted asset data, and stores the asset data in asset tracker data format (such data occasionally being referred to herein as processed asset data), as described herein. Asset tracker 110 then allows using the formatted data, processed asset data, to accomplish workflow tasks as described herein and with respect to FIGS. 5-8.

Asset data fetcher 160 communicates with asset data sources 102 to extract asset data therefrom. In particular asset data fetcher 160 may communicate with processor 112 to extract the asset data. In one embodiment, processor 112 may expose application programming interfaces (API) to asset data source 102, asset data databases 132 and tables 122. Asset data fetcher 160 may then execute programming instructions for the specific asset data source 102, calling the API provided by the specific asset data source 102, to obtain the asset data contained therein. This may be substantially similar to constructing structured query language (SQL) queries for a particular asset database 132 and table 122. Asset data fetcher 160 may be implemented, for example, in Java™ or C++, for example, and may use commonly available SQL tools. Asset data fetcher 160 may implement callback functions, as described herein, to retrieve the required data. One or more callback functions may be used for each class, each attribute and each asset data source, for example. Multiple callback functions may access the same database/table/column/record from a particular asset data source. Each class, as described herein, may have a schema (which may be an XML file, as described herein) for each asset data source 102 from which data fetcher retrieves data for the class.

Asset data fetcher 160 then provides the extracted data, or at least a portion thereof, to asset data filter 152. Asset data fetcher 160 may have a mapping of asset data sources 102 to filters 152 so that data from a particular asset data source 102 is provided to a particular filter 152.

Fetcher 160 is described herein as “pulling” asset data from asset data sources 102. However, asset data sources 102 may also “push” data to fetcher 160, or asset tracker 110. In such a case, fetcher 160 may not be required, provided the proper data can be received by asset tracker 110 from asset data sources 102.

For example, each asset data source 102 may be provided one or more maps or schemas of data that needs to be assembled and provided, or made accessible to, asset tracker 110. Each asset data source 102 may be provided, for example, a schema for data that needs to be assembled for each class described herein. As such maps of data that are assembled by asset data sources 102 may be already assembled for a particular class. Many known approaches to assembling and pushing data, between various databases or computer systems, may be employed, provided that the contents of the data that is assembled, how it is combined with data from other asset data sources 102, and how it is processed and/or stored in asset tracker 110 permits aspects of the invention described herein. In one embodiment of the present invention, each asset data source 102 may have a system to execute SQL queries to retrieve the required data, arrange the queried data, and provide the arranged data to asset tracker 110. Such system may be in the form of computer readable instructions stored in computer readable media, executable by a processor.

Filter 152 may receive data from asset data fetcher 160 and then relate, process and format the asset data received.

Relating the data may involve comparing asset data between other asset data filters 152 to determine what asset data from other asset data filters 152 the data relates to. For instance, Filter 152 may receive data about 100 widgets, purchased on a given date, from a particular vendor. Relating may involve comparing asset data from filters 154/156/158 to find other asset data relating to those specific 100 widgets. Of course the asset data that filter 152 receives will depend on what asset data source it receives data from, and similarly for other filters 154/156/158.

Processing the data may involve altering or cleaning the data. Specific examples of such processing typically relate to a particular asset data source. Exemplary processing includes:
(a) CM system 104 may process various types of agreements (contracts, statements of work (SOW), contract amendments, licenses, etc). Processing may involve parsing the agreements to separate various legal terms located therein (such as limitations of liability, representations and warranties, return policies, term and termination rights, and the like). In this way, filter 154 may create a library of contractual terms for particular vendors, products and the like. Contractual terms can then be compared, searched, and re-used or reviewed as required. Such processing may involve starting from non-machine readable formats (such as PDF™) and converting into machine-readable formats (such as by using OCR technology), for example before parsing may occur.
(b) Several asset data sources may include information about the actual assets (such as SKU numbers, names, identifiers, and descriptions). However, such information may not be complete and/or may not fully identify the asset as may be required for various of the workflows to be performed. As such, processing may include obtaining information about the actual asset and using filters 152/156/158 to determine a universal code to identify the asset (such as the United Nations Standard Products and Services Code™ (UNSPSC)). In one embodiment, asset descriptions from one or more data fields from one or more asset data sources 102 may be used in a lookup table to determine a suitable UNSPSC for such asset. In storing asset data in asset tracker data format, for example in tables 130 in asset tracker database 140, the determined UNSPSC may be included therewith. This may permit workflows, as described herein.

Formatting the asset data may involve selecting which data records, fields, datasets, and the like are to become part of the asset tracker data, what order they will be inserted in asset tracker database 140, and in what table 130, what data structure to store in, and formats for dates, prices, and the like. Formatting may result in asset tracker data being in asset tracker data format.

Asset tracker database 140 may be substantially any database system that can store asset data. Asset tracker database 140 can perform standard database operations such as creates, reads, updates, and deletes (CRUD) and may be accessible, for example, using SQL or other query languages. Such operations may allow ingestion of data from filters 152 and providing data to asset tracker application server 120. Asset tracker database 140 may comprise one or more tables 130 for storing asset tracker data.

By the time data is stored in asset tracker database 140 it may be asset tracker data (processed data) and in asset tracker data format. Asset tracker data, or processed data, as used herein, refers to the any and all required data relating to a particular, specific, asset or group/collection of assets. Asset tracker data may comprise of asset data from one or more asset data sources. For example, if corporation “ABC” owns widget “XYZ”, there will be data in one or more asset data sources 102 relating to XYZ. Asset tracker data would involve assembling all required asset data, relating to XYZ, from each asset data source 102 having such data for ABC.

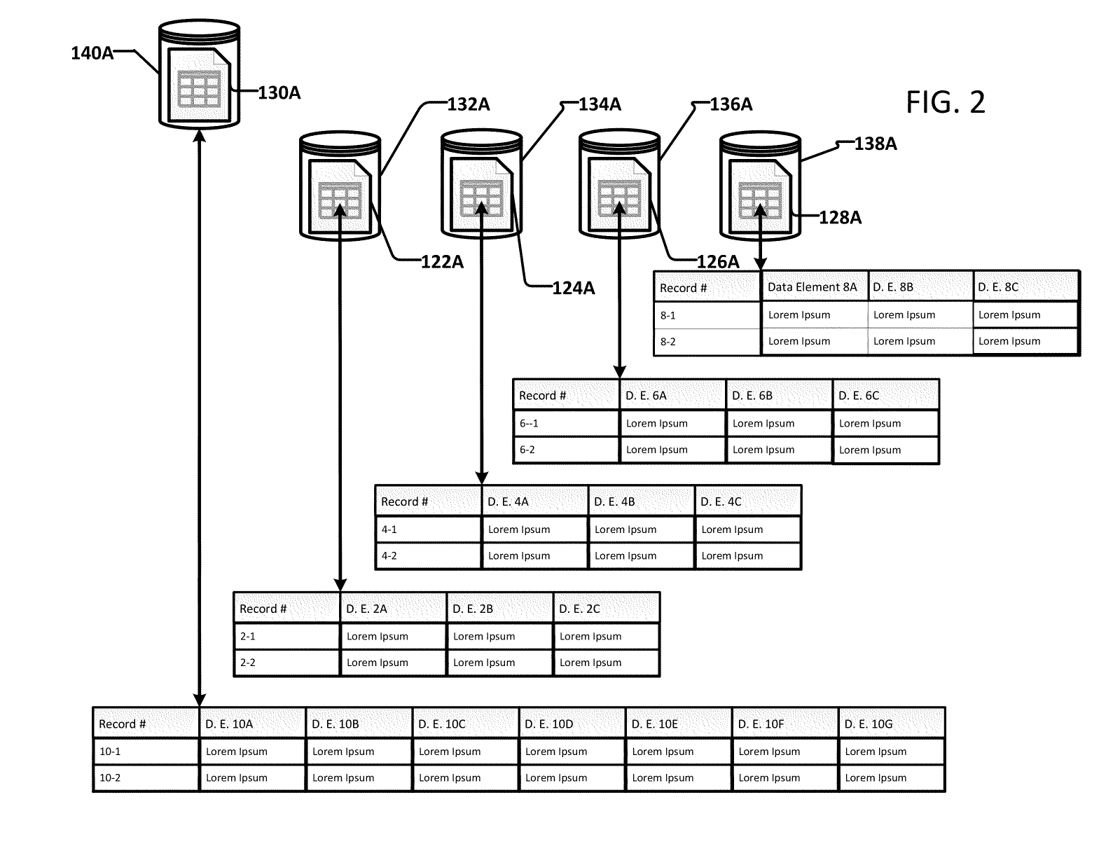

Asset tracker data format is a format from which data can be readily used to perform the workflows and functions of asset tracker 110 as described herein. Such data format may allow for, for instance, simple creation of SQL queries to read or modify data, or perform other operations as described herein. Such data format may be implemented using one or more tables 130 in asset tracker database 140. One embodiment of asset tracker data format (processed data or processed datasets) is described below and with respect to FIG. 2. Of course, it is to be understood that different formats and specific details of a format are within the scope of the invention, including different numbers of classes, attributes (and sources of those attributes), callback functions, XML files (their structure or even their presence) and the like.
(a) Asset tracker data format may comprise five classes: “Product”, “Contract”, “Vendor”, “Deployment” and “Schedule”.
   (i) “Product” may have the following attributes, and attribute sources (“attributes” being synonymous with “data elements” in FIG. 2):
      (A) Vendor: from CM system 104 vendor name
      (B) Name: from ERP system 108 asset name
      (C) Identifier: from PR 102 and/or AM 106
      (D) Code: from asset tracker filters
   (ii) “Contract” may have the following attributes and attribute sources:
      (A) Vendor: from CM 104
      (B) Effective Date: from CM 104
      (C) Term: from CM 104
      (D) Product purchased: from CM 104 and/or PR 102
      (E) Deployed products: from ERP 108 and/or AM 106
      (F) Terms and conditions: from CM 104
   (iii) “Vendor” may have the following attributes and attribute sources:
      (A) Name: from CM 104, PR 102, AM 106 and/or ERP 108
      (B) Products from Vendor: from PR 102 and/or AM 106
      (C) Payment terms: from PR 102 and/or CM 104
   (iv) “Deployment” may have the following attributes and attribute sources:
      (A) Product deployed: from PR 102
      (B) Date deployed: from AM 106
      (C) Termination (if applicable): from CM 104
      (D) Location deployed: from AM 106
   (v) “Schedule” may have the following attributes and attribute sources:
      (A) Date: from PR 102 and/or ERP 108
      (B) Product: from PR 102 and/or ERP 108
(b) Each class may have an XML file that maps the appropriate database(s), table(s) and column(s) from the appropriate asset data sources 102, into the class and into asset tracker database 140.
   (i) For example, the “Contract” class' XML file may include a <database> object for contract management database 132A, table 122A and data elements 2A, 2B and 2C (that may be the vendor name, asset description and effective date respectively). These data elements may be part of the “Contract” class, and therefore part of table 130 in asset tracker database 140 in FIG. 2 (and may be inserted, for example, into the columns having “Attribute” values DE 10A, DE 10B and 10C).
   (ii) An exemplary XML file may be:

```
<class>
      <name></name>
      <database>
            <type></type>
      <uri></uri>
      <name></name>
      <user></user>
      <password></password>
      <source_table>
            <name></name>
            <source_column>
                  <name></name>
                  <callback></callback>
                  <attribute></attribute>
            </source_column>
      </source_table>
      </database>
</class>
```

(iii) Where:
   (A) “Callback” is a method to which data from asset data sources is passed.
   (B) “Attribute” is the class attribute to which the data will be mapped (for example “Product” class, “Vendor” attribute). “Attributes” may be one of the data elements in FIG. 2, for example DE 10A, such that a data element from an asset data source 102, such as DE 2A may be mapped to DE 10A.
(c) Each <database> may be an asset data source database (such as 132/134/136/138) and may have further information, such as:
   (i) Information about the database and connecting to it:
      (A) Name: the name of the actual database to connect to, noting that the URI may only be the host.
      (B) Application/Type—what type of database is being connected to, such as Oracle™, SQLServer™, MySQL™, or Access™
      (C) URI/HOST: this may be a jdbc connection uri or a hostname.
      (D) User/Password: The login credentials for the database.
      (E) Other information as required.
   (ii) Exemplary database information, for within a <database>, may be:
      Table name: production
      Application/Type: SQL Server 2010 Datacenter Edition™.
      URI/Host: cal21.eastverizon.com
      OS: Windows server 2008
      Patch Level: r2 SP 3
      Deployed: 2011-07-15.
   (iii) Information relating to sources of data for a particular class:
      (A) One or more source table(s) from tables 122/124/126/128
      (B) One or more source column(s) from the one or more tables 122/124/126/128 such as Data Element 8A and DE 8C from a first table from table 128)

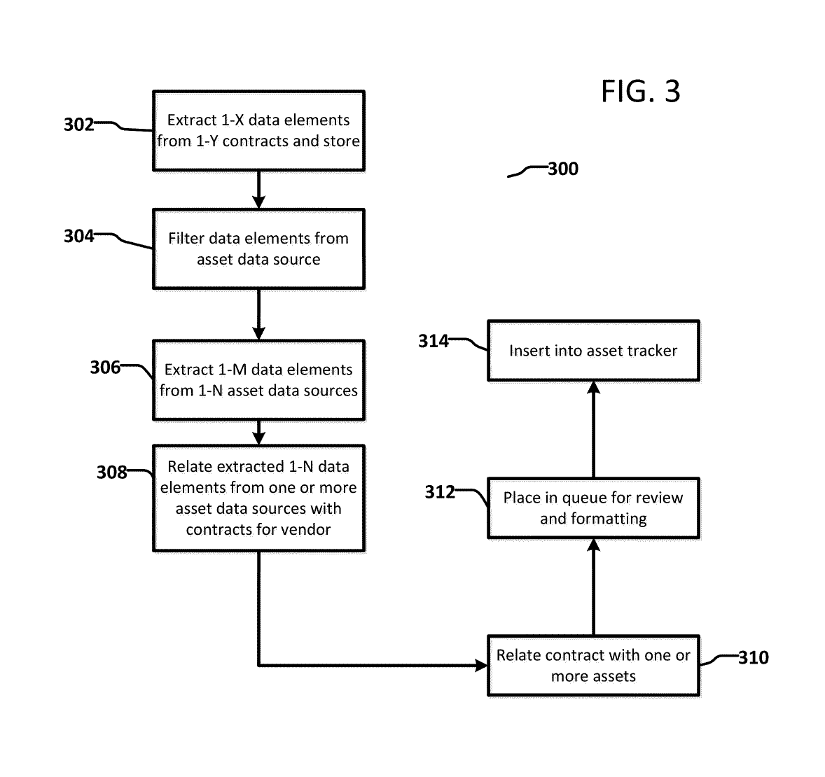

Data server 120 allows one or more users of asset tracker 110 to interact with asset tracker 110, for example via UCD 170. Such interaction may be facilitated by data server 120, possibly in combination with other aspects of asset tracker 110, providing user interface elements that may be communicated to UCD 170. Data server 120 may perform substantially all of the functioning required to implement the workflows, methods, and functionality, used or accessed by a user via UCD 170, of asset tracker 110, such as described herein and with respect to FIGS. 3-8.

CD 170 may be substantially any computing device (PCs, smart phones, tablets, servers) that can interact with other computing devices such as application server 120. UCD 170 may preferably have one or more displays and user input devices (not shown) to facilitate interaction with asset tracker 110. UCD 170 may enable one or more of the workflows and functionality described herein to be accessed by a user of asset tracker 110. Of course one or more UCD 170 may be able to access asset tracker 110, and may be employed in a software-as-a-service, or another configuration with respect to asset tracker 110.

FIG. 2 is a diagram of aspects of data structures and elements for asset-tied transactions according to a non-limiting embodiment of the present invention.

Table 130A in FIG. 2 may be one of the one or more tables in database 140A, which may be one of the one or more databases in asset tracker 110. Database 140A may be a database for a particular asset tracker class, as described herein. Table 130A may then have records, each record having one or more data elements (DE10A-10G). These data elements (DE10A-10G) may comprise one or more data elements from each of the one or more asset data sources having data about a particular asset. Each asset data source may have at least one data element that none of the other asset data sources have. Each of the data elements may be an attribute of the class in question. Table 130A may be considered a sink table, database 140A a sink database and data elements 10A-10G sink data elements.

Similarly table 122A in FIG. 2 may be one of the one or more tables in database 132A, which may be one of the one or more databases in asset data source 102. Each of the other table/database combinations shown in FIG. 2 may be similar portions of their respective asset data sources. Database 132A may be a database in a particular asset data source, as described herein. Table 122A may then have records, each record having one or more data elements (DE 2A-2C). Each of databases 134A/136A/138A similarly have data elements, as shown in FIG. 2. Each of these databases, tables and data elements may be from asset data sources and may be considered source databases, source tables and source data elements.

Each of data elements 10A-10G may come from one or more source data elements. Not every source data element may become a sink data element (for any sink table, sink database, sink data element or at all). In other words, not all source data may be required for asset tracker 110. However, assuming in the example shown in FIG. 2, that a row in table 122A relates to a single asset, then each data element column would relate to that asset (ie the columns may be “vendor”, “asset identifier”, “deployment date”, “number consumed or deployed”, and the like) and each cell would have data for that column relating to that asset (ie who the vendor was for the asset, what the identifier is, when it/they were deployed, etc).

Of course it is to be understood that there may be substantially any number of sink tables, databases and data elements and any number of source tables, databases and data elements. Further, any relationships, for any classes described herein or that may be required or employed, is within the scope of embodiments of the present invention. Examples of such mappings are described herein with respect to attribute/attribute source pairs.

FIG. 3 is a flowchart depicting a method 300 for inserting asset data according to a non-limiting embodiment of the present invention.

Method 300 extracts data from one or more asset data sources 102 and relates, processes and formats the extracted data for insertion into asset tracker 110. Method 300 may be employed one or more times for each data source 102, or each collection of data sources, in establishing asset tracker 110 for the first time. As used herein, a collection of data sources 102 may refer to the set of data sources 102 housing all required asset data for a given company. Additionally, method 300 may be employed throughout the normal operation of asset tracker 110, such as to retrieve updated asset data, provide updated asset data to data sources 102, add data sources 102, or other times as described herein.

By the time method 300 is employed, asset tracker 110 may already know which data sources 102 are to be used. If not, they may first be determined. Of course it is to be understood that due diligence may be performed on a client environment prior to method 300 being employed. Such due diligence may include, for example, determining what data data sources 102 are used, and what software packages may comprise such data sources 102, the amount and condition of the asset data therein, networking issues or questions for communication with such asset data sources 102, and the like.

Method 300 then begins at 302 to extract data elements or datasets from the relevant contracts and store those data elements. Such extraction may occur on a “record-by-record” basis (each contract or other entry being a record for example), may be done in batches, or in another suitable order. The data elements to extract may be as described with respect to FIG. 2; the contracts may be extracted from CM 104. Each of the 1-Y contracts may be extracted, and their 1-X data elements parsed and stored, for example as described with respect to processing of CM 104 and with respect to FIG. 2. This step may allow asset tracker to know all of the contracts, relating to all of the assets, for which data will be extracted and collected from other data sources 102. It is to be understood, with respect to 302 and 402, that a particular contract may have several amendments thereto, new versions, statements of work, work orders, change orders, and the like. All contractual terms may be extracted, processed and related, as described herein. Exemplary CM 104 may in fact provide assistance in ensuring that all relevant terms are considered.

Of course, some assets for which there is asset data (for example in data sources 102 other than CM 104) may not have a contract related thereto in CM 104. Such assets will be handled separately, and may result in asset tracker 110 creating a “placeholder” contract for that particular asset. A user may later replace the placeholder with an actual contract or provide other details about the assets (such as confirming the terms related to their purchase) via UCD 170, for example. Similarly there may be contracts for which the assets cannot be located (either physically or in other asset data sources 102). Asset data tracker 110 may similarly allow a user to manually add assets (including to records that would be filled by other asset data sources 102) or may allow a user to ignore or remove the contract record(s).

Method 300 then continues at 304 where data elements are extracted and filtered from data sources 102. This may involve fetcher 160 interacting with the data sources 102 to remove asset data, possibly in a bulk fashion. At the end of 304, there may a large amount of data, in various formats, from asset sources 102. Such data may be temporarily stored in memory at asset tracker 110, for example, so that it may be further extracted, related and formatted.

At 306 method 300 proceeds to extract 1-M data elements from 1-N asset data sources 102. During this step data elements from each data source are extracted so that records from different data sources 102 can be related to each other and to one of the contracts extracted in 302. The data elements extracted from each asset data source 102 may be substantially as described herein and in particular with respect to FIG. 2. As a result of 306, there may be multiple records, from each of the data sources 102 in the relevant collection, with each record being separated into its constituent data elements.

Method 300 then continues at 308 where 1-N data elements from one or more data sources are related to contracts for a vendor. By way of example, ERP 108 may be part of the collection and may store data records according to invoices (ie a data record will contain all the relevant asset data for a particular invoice). At 306 each line item of the invoice may extracted, along with the vendor. At 308 then the data record may be related to a contract with a vendor that was extracted (including the vendor name) at 302. In a simple scenario, at 308 the vendor name is matched to the one contract having the same vendor name. In such a simple example, the vendor name may be the data element that is compared between asset data sources to ensure that the same assets are being referred to.

At 310, once data elements have been related to a contract, the contract is related to one or more assets. For example, ERP 108 may indicate an asset that was purchased from a vendor. At 310, after relating the data elements with the contract at 308, the contract is related with the one or more assets that were identified as being purchased in the ERP 108 record.

At 312, the data elements, and relations established in method 300, are placed in a queue for review and formatting. This may include a final review to ensure that all required data elements have been located and included, that all data sources 102 in the collection have been extracted from, that potential mismatches of contracts/assets/asset data have been rectified, and the like. Formatting may then involve modifying the data elements, as described herein, to make sure the asset data is in the proper asset tracker format. At the end of 312 there may be an asset tracker data record, in asset tracker data format, that is to be inserted into asset tracker.

At 314 then, the asset tracker (or “processed”) data record or dataset is inserted in asset tracker 110, for example into one or more tables 130 in asset tracker database 140.

Method 300 may be repeated until all data elements and all contracts, have been accounted for (ie either inserted into asset tracker 110, rejected, or identified as requiring further investigation—for example manual review).

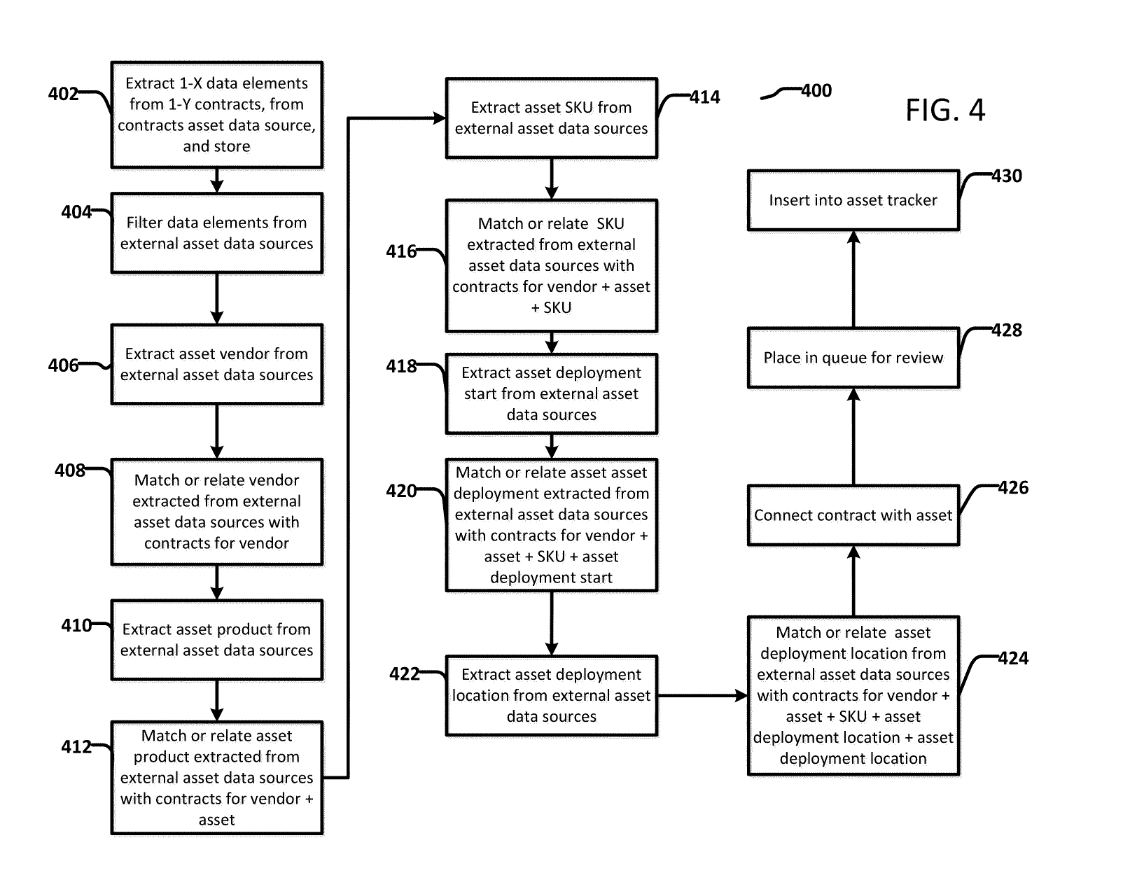

FIG. 4 is a flowchart depicting a further method 400 for inserting asset data according to a non-limiting embodiment of the present invention. Method 400 may be a preferred or more specific implementation of method 300 and may be intended to accomplish substantially similar end results of asset data being inserted into asset tracker 110.

Method 400 begins at 402 where data elements, or datasets containing data elements, are extracted from contracts that may be in CM 104. Such extraction includes extracting, from each record or dataset, data elements as described with respect to FIG. 2, and may include at least a vendor and one or more data elements (asset description of some form, one or more SKUs, product ID, effective date(s), deployment location) to identify the one or more assets to which the contract relates.

At 404 data elements are extracted from asset data sources 102. This extraction may be done, for example, by data elements across records (or across asset data sources 102), with respect to a specific record, or another manner of dividing the data for filtering.

At 406 asset vendors are extracted from asset data sources 102, with respect to a particular record.

At 408 the vendor extracted from asset data source 102 is matched or related to contracts for the same vendor, extracted in 402.

At 410 the assets in question are extracted from asset data sources 102.

At 412 the extracted asset from asset data source 102 is related to contracts for the vendor and asset extracted in 402.

At 414 the asset SKUs in question are extracted from asset data sources 102.

At 416 the extracted asset from asset data source 102 is related to contracts for the vendor extracted in 402. This may involve, for example, matching the vendor name, asset descriptions, purchase or deployment dates, and the like.

At 418 the asset deployment start in question is extracted from asset data sources 102.

At 420 the extracted asset from asset data source 102 is related to contracts for the vendor, asset, SKU, and asset deployment start extracted in 402. Matching or relating, as described herein, may substantially involve comparing the values for the data elements in question (for example seeing if the vendor is the same). In a slightly more complicated example, matching or relating may involve determining if the contract execution date is before the deployment start date (as this may render more likely, though not necessarily guarantee, that the contract in question relates to the particular deployment). In a further example, a contract to purchase 100 professional services hours (in CM 104 for example) may be tied to the number of hours received (and possibly paid) in invoices in ERP 108. If the number of hours invoiced is less than the hours purchased under the particular contract, then the contract and the “asset” (professional services hours) may be matched or correspond. In yet a further example, a contract to purchase widgets from a vendor may have a maintenance amount associated therewith in CM 104. In ERP 108 there may be invoices for maintenance for that vendor's widgets. If the maintenance amounts match then the data may correspond, but if the amounts do not match then the invoices in ERP 108 may relate to a different contract in CM 104, or possibly an exception may exist that requires further attention. As such, the matching or relating may involve determining correspondence, which may be more than simply if the values are the same.

At 422 the asset deployment location in question is extracted from asset data sources 102.

At 424 the extracted asset from asset data source 102 is related to contracts for the vendor, asset, SKU, asset deployment start, and asset deployment location extracted in 402.

As described above, with respect to 308, at 424 data elements are compared between datasets or records of more than one asset data sources (for example two asset data sources or the primary and one secondary). As described in 424, several data elements are compared to ensure that the data from the two data sources relate to the same data. In the case in 424 more data elements were required for a positive match or relation. It is to be understood that the compared (and matched) data elements may be stored (for example as in 430), along with other data elements that are unique to the particular asset data sources (and hence not compared) but that may be required by asset tracker (for example to accomplish some or all of the workflows, also known as monitoring, described herein).

As can be seen with reference to 308 in FIGS. 3, and 406-426, the methods extract and relate various data elements from asset data sources 102 with various data elements from data source 104 (CM 104) to attribute particular assets with the contracts that govern their use (and other terms of course). By the end of 308, and 426, either method may have positively identified the contract applicable to data extracted from data sources 102. As such, many facts, relevant for workflows as described herein, will be known such as:
(a) for any given asset, the contract pursuant to which it was purchased will be known;
(b) for each contract, the assets deployed thereunder (numbers, locations and deployment dates), and the assets that may still be deployed, will be known;
(c) costs under each contract will be known;
(d) costs per SKU number will be known;
(e) contract term (start and end date);
(f) usage rights;
(g) reports on a particular purchase requisition number, clients, purchase order number, geographic locations for assets, delivery locations for assets, cost centre, project number, or the like (where each of such reports would provide data from disparate asset data sources, enabling a comprehensive view)

Method 400 may proceed to 428 and 430, which may be substantially similar to 312 and 314, respectively. Method 400 may similarly repeat as required, for each dataset/record/data element in any asset data source involved.

FIGS. 5-7 are flowcharts depicting methods for using asset tracker according to non-limiting embodiments of the present invention.

In all such situations, FIGS. 5-7 are depicting some of the functionality of asset tracker 110, which assist with, or accomplish workflows of various users of data sources 102. Many other functionality and workflows are possible.

Turning to FIG. 5 there is a method 500 for initiating a purchase of an asset using asset tracker 110. In FIG. 5 a user wants to use an asset but wants to know if they have an extra one available across the enterprise before purchasing one. They would then use asset tracker 110 to look for such an asset before using asset tracker (or purchase requisition system 102 as would occur in many current workflows) to purchase an asset.

Method 500 begins at 502 where such a request is made. Such a request may be made by a user of asset tracker 110, such as a procurement, finance, legal or other corporate user accessing asset tracker 110 (and its functionality) for example via UCD 170.

At 506, a determination is made whether there is a contract governing the purchase of such assets. Of course, such may be made with reference to asset tracker data in asset tracker database 140, for example by searching for contracts, amendments, statements of work, etc, relating to the asset.

If there is a contract then method 500 continues at 508 to determine whether there is any inventory of such asset to be deployed. For example, if a contract and/or invoice, extracted from asset data sources 102 and inserted in asset tracker database 140, contained the purchase of 10 widgets, and widget asset data, inserted in asset tracker database 140 from asset data source 102 indicates that nine widgets have been deployed throughout the enterprise, then there remains one widget for deployment.

If there are assets to be deployed then at 510 the asset may be redeployed—essentially making is useable as per the reason for the original request for purchase in 502.

Information relating to the redeployment may then be entered into asset management system 106 at 512 (or any other asset data source 102 as may be required). This may involve entering information relating to the deployment in asset tracker 110 and/or asset management system 106—and having either system provide updated information to the other.

As discussed with respect to 512, and as applicable throughout methods and functionality of embodiments of the present invention, asset data sources may be updated by asset tracker 110, asset tracker 110 may be updated by asset data sources, or both may occur.

In one embodiment, asset tracker 110 may be initially populated upon startup by extracting all required information from asset data sources 102. Asset tracker 110 may then be conferred, as described herein, during various workflows and to perform various functionality. Whenever data in underlying asset data sources is to be changed (amended, added, deleted, etc), the change may be made directly to the applicable one or more asset data sources 102. An update operation, performed by or on asset tracker 110 and as described herein, may cause the change to permeate to asset tracker 110. In method 500 for example, redeployment at 510 may be accomplished by inserting the new asset deployment information in asset management system 106, and then the data may be extracted and inserted into asset tracker 110 during an update operation.

In a further embodiment, asset tracker 110 may again be initially populated upon startup by extracting all required information from asset data sources 102. However, if workflows and functionality in asset tracker 110 (as described herein) result in changes to underlying data, the changes may be recorded in asset tracker 110 and then distributed to the asset data sources that require the information.

Returning to method 500, if either there is no contract at 506 or there is no inventory at 508, then an agreement to purchase the asset needs to be arrived at. This begins at 514 where pricing and terms and conditions (“Ts and Cs”) are negotiated.

Once negotiations have been completed data may be captured at 520. Such data capture may be substantially as described above with respect to 512—where data entry may originate with asset tracker 110 or with the underlying one or more asset data sources. Captured data, after 514, may include pricing into purchase requisition system 102, part numbers, SKUs, deployments and product/service descriptions into asset management (AM) system 106, and the like.

As data is captured at 520 (or before/after, but possibly in parallel to some extent), method 500 continues at 516 where a contract is executed. Again, after 516 data is captured at 520. It should be noted that data capture step 520 is relevant at various stages of method 500 and is used interchangeably herein. At each occurrence of method 500 arriving at 520 different data may be captured. Essentially 520 ensures that all data required by any of asset tracker 110, or any asset data sources, is captured. Although embodiments are described herein, required/desired data for capture may be different and may in fact be configurable between users (corporations) or asset tracker 110.

Method 500 may proceed to 518 where various other steps in the procurement process may be undertaking—for example issuing a purchase order, receiving the asset, and paying the invoice. Throughout any or all of these steps, possibly occurring in various departments across an organization and using various asset data sources, data is being captured.

Method 500 then arrives at 522 where the purchased assets are deployed and managed—again with that deployment and management data being captured.

As shown in FIG. 5, at 504, required data will end up in asset tracker 110 (and asset tracker database 140 in particular). The way, and order, this happens can vary substantially, as described herein.

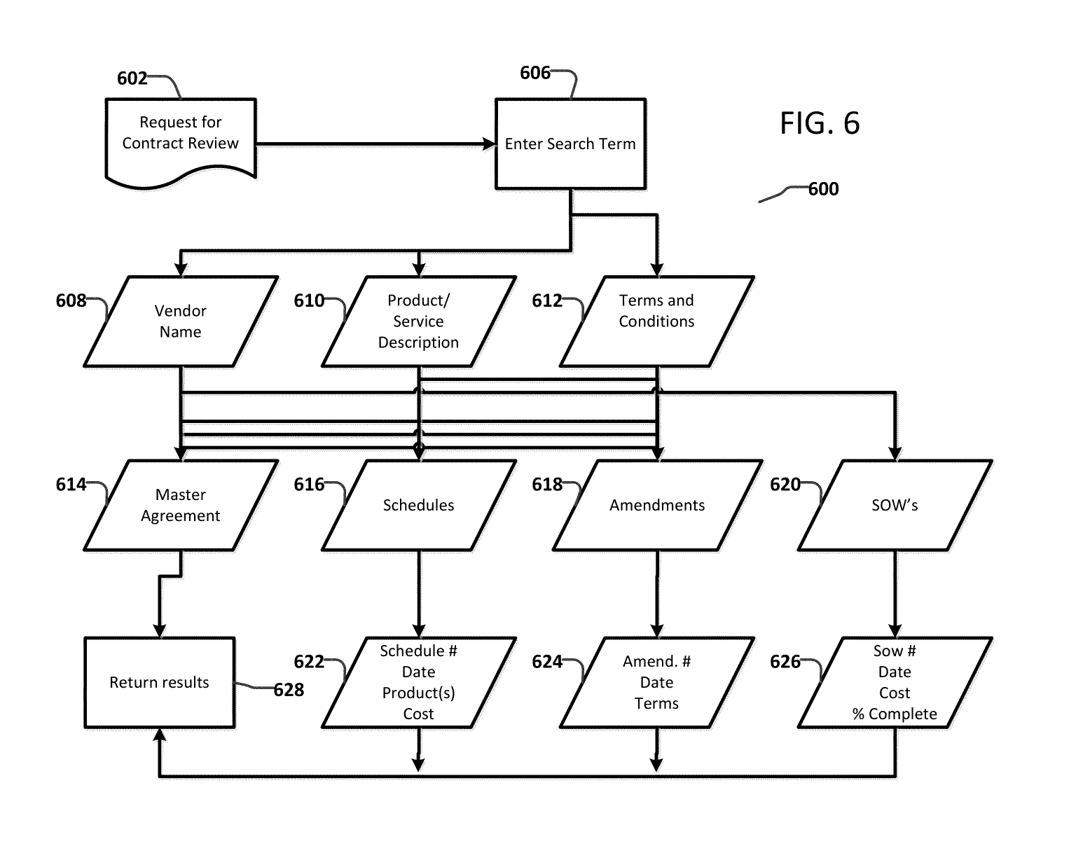

Now turning to FIG. 6 there is a method for requesting to consider contractual terms. In FIG. 6, a user wants to view and consider contracts applicable to the purchase of one or more assets.

At 606 search terms are entered, for example by a user with UCD 170. Exemplary search terms may include or be directed to vendor names (as at 608), product/service description (as at 610), or language from within Ts and Cs in contracts (as at 612).

Vendor names may be searched at 608, for example to understand the relationship with a particular vendor (the history of purchases, returns, disputes, etc), to identify contract start and end dates (for example for services contracts, license terms and the like) or perhaps to investigate a dispute that has arise.

Product/service descriptions may be searched at 610 to find information about a particular asset or assets. For example, a searcher (perhaps a contract administrator that used to use CM 104 to manually attempt this) may want to review all agreements that relate to the purchase of widgets (across all vendors from whom widgets have been purchased). This may assist in negotiations for future widget purchases, for example.

Ts and Cs may be searched at 612 to compare terms relating to one or more asset purchases. During contract negotiations, reference is often made to “market” terms—generally by a party seeking the other to concede as the other's request is not customary. Such a search at 612 may assist in determining whether a party agrees that a term is market, may provide support that a particular party's “market” is different from a claimed “general market”, may assist in due diligence exercises (such as for mergers and acquisitions, compliance audits and the like).

Regardless of whether the entered search terms are directed according to 608, 610 or 612, master agreements (at 614), schedules (at 616), amendments (at 618) and SOWs (at 620) may be included in the search. Of course it is to be understood that any portion of an agreement may be searched, regardless of whether the agreement takes on one or more typical parts, as described with respect to method 600.

If schedules, amendments or SOWs are included in the search results, various details about the particular schedule/amendment/SOW the result was found in may be extracted and included as part of the results for the contract review request—as shown in 628.

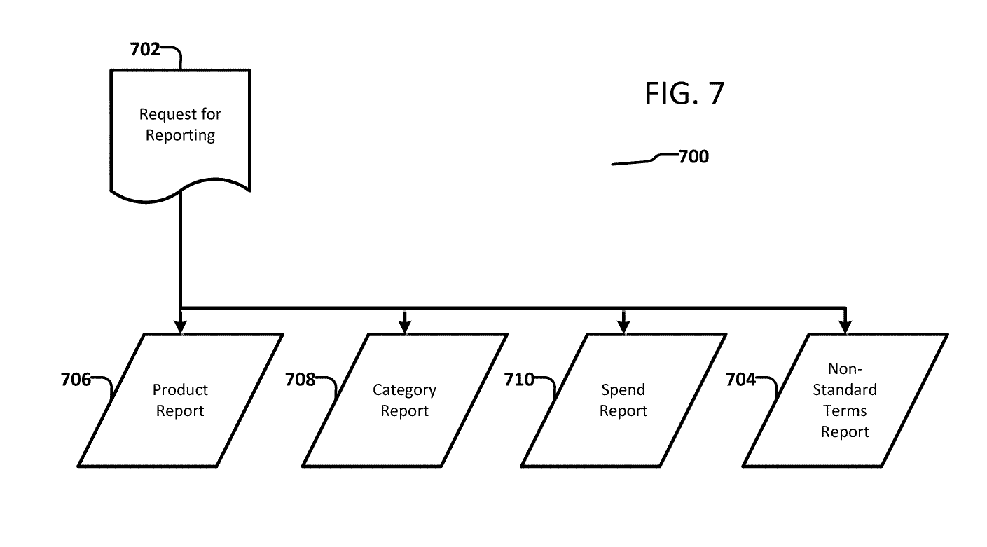

Finally, turning to FIG. 7 there is a method 700 for accessing reporting functionality of asset tracker 110 according to an embodiment of the present invention. Method 700 is fairly straightforward, starting at 702 where a request is made for reporting functionality. Such request may be made, for example, by a user via UCD 170.

Such request may be directed to product reports (at 706), category reports (at 708), spend reports (at 710) or non-standard terms report (at 704).

Of course it is to be understood that many different reports, and combinations of reports may be possible based on the asset data in asset tracker 110. Any of the reporting functionality may allow for workflows to be accomplished, as described herein.

Exemplary reports may include:
(a) Product Reports:
   (i) Total Qty Purchased by Vendor
   (ii) Total Qty Purchased by Part Number (SKU, Description, Etc.)
   (iii) Total Qty Purchased by Date
(b) Category Reports:
   (i) Total Spend in Software Category
   (ii) Report of all Vendors in Server Hardware Category
   (iii) Report of all Products Purchased in Furniture Category
   (iv) Report of all Vendors that have sold products in both the IT Hardware and Software Categories
(c) Spend Reports:
   (i) Total Spend by Vendor
   (ii) Total Spend by Part Number (SKU, Description, Etc.)
   (iii) Total Spend by Date
(d) Non-Standard Terms
   (i) Report on all Vendors with payment terms less than net 45/30/etc
   (ii) Report on all vendors with a Non-Standard Indemnity (or Liability, Warranty, Confidentiality, etc. as compared to the corporate standard)
   (iii) Report on all vendors who do not have acceptance language (or non-compete, or Service Level Agreements, etc.)

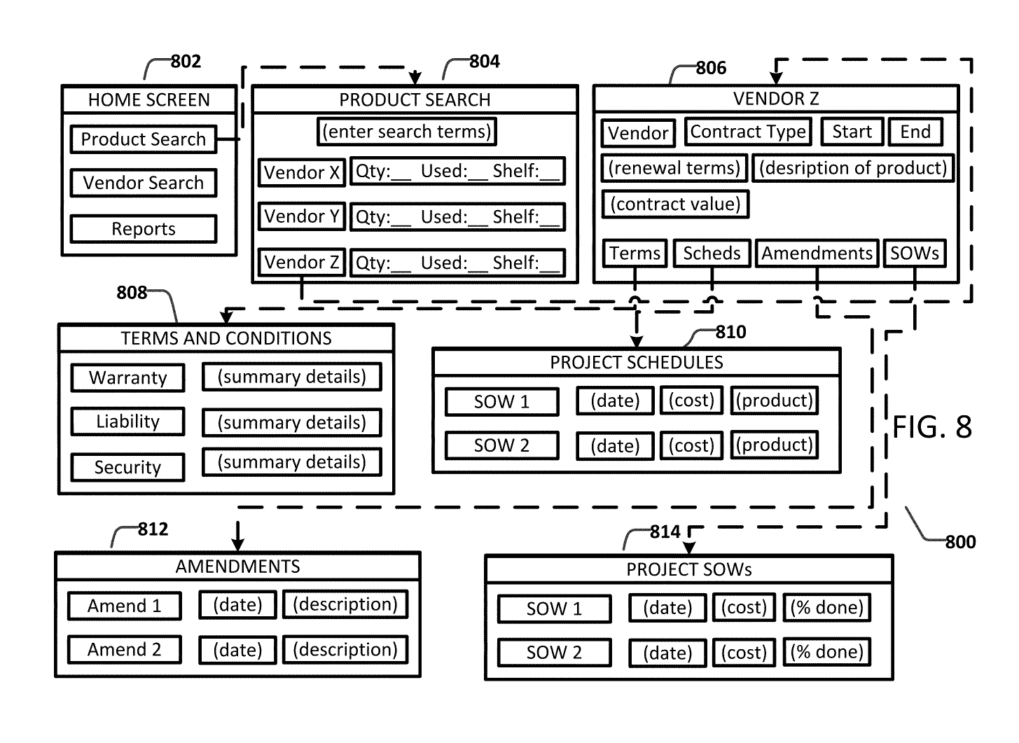

FIG. 8 is a diagram of user interface sequences for a system for identifying and relating asset-tied transactions according to a non-limiting embodiment of the present invention. In particular in FIG. 8 a sequence of user interfaces for a product search is presented.

It is to be understood that any of the methods shown in FIGS. 5-7, or any of the methods or workflows shown and described herein may be implemented using the systems shown herein. Although FIG. 8 shows user interface elements that may be used to accomplish one or more of such workflows, it is to be understood that other user interface elements may be used to accomplish this or other workflows.

Method 800 begins at 802 where a user is able to select between main functionalities, such as may be offered by asset tracker 110 and asset tracker application server 120 in particular. In 802, a user may select the product search option, resulting in asset tracker application server 120 presenting 804 to the user.

At 804 a search term (an asset or product) has been entered, and a resulting search has returned that the asset has been purchased from vendors X, Y and Z, with the quantities purchased, quantities deployed and quantities available presented. Where quantities are available, a redeploy option may be presented. At 804 a user may select to view information relating to the assets purchased from vendor Z.

At 806 such information is presented and may include information about the assets purchased from a vendor, such as a vendor name, the contract type, start and end dates, renewal terms, asset descriptions and contract value. Of course it is to be understood that both the asset data, and layout are exemplary only. Also presented may be further options to view more detail, such as to further a workflow.

Selecting terms and conditions in 806 may result in 808 being presented. Selecting product schedules in 806 may result in 810 being presented. Selecting amendments in 806 may result in 812 being presented. Selecting SOWs in 806 may result in 814 being presented. It is to be understood that not only may extracted information be presented, a user may be able to view the underlying document if desired.

In 808 a user may be able to search the terms and conditions for search terms. Further, particular provisions of the Ts and Cs may be individually searched as they have already been extracted by asset tracker 110. Conveniently, an indicator may be presented to show whether resultant terms in the vendor's contract (or SOW/Amendment/etc) are standard or not.

In 810, schedule information may be presented to a user, such as dates, products and costs involved in each schedule to a vendor's agreement.

In 812 each amendment may be listed, and the date it was effective and a description thereof may be included.

In 814 SOWs may be presented, along with various information related thereto. Related information to display may include deliverables, acceptance criteria, milestones, resource names/descriptions, and rates In particular, and in furtherance of governance or agreement (SOW, license, terms and conditions) compliance workflows, an indicator of compliance may be shown. This may be accomplished, for example, by ensuring and tracking that the proper deliverables have been received and accepted, milestones have been met, and invoices paid.

It is to be understood that each search initiated, button selected, asset data shown in a user interface element, and the like, may all be obtained from asset tracker application server 120 and asset tracker database 140, for example via execution of SQL queries, and other computing instructions.

It will be apparent to one of skill in the art that other configurations, hardware etc may be used in any of the foregoing embodiments of the products, methods, and systems of this invention. It will be understood that the specification is illustrative of the present invention and that other embodiments within the spirit and scope of the invention will suggest themselves to those skilled in the art. All references cited herein are incorporated by reference.

What is claimed is:

1. A method for monitoring assets throughout an organization, where data relating to such assets are stored and processed in disparate asset data sources, including a primary asset data source having one or more primary asset datasets, each primary asset dataset relating to an asset and containing primary asset data elements about the asset to which they relate, and one or more secondary asset data sources, each having one or more secondary asset datasets, each secondary asset dataset relating to an asset and containing secondary asset data elements about the asset to which they relate, the method comprising:
receiving, by an asset tracking module on a processor, the one or more primary asset datasets from a primary asset data source;
for each secondary asset data source and each secondary asset dataset therein:
obtaining, by an asset tracking module on a processor, a secondary asset dataset from the secondary asset data source;
relating, by an asset tracking module on a processor, the secondary asset dataset to one of the one or more primary asset datasets;
processing, by an asset tracking module on a processor, the one or more primary datasets and the related secondary datasets into processed asset datasets;
storing, by an asset tracking module on a processor into a database on a computer readable medium, the processed asset datasets; and
tracking, by an asset tracking module on a processor, the assets using the processed asset datasets.

2. The method of claim 1 wherein the relating further comprises:
comparing, by an asset tracking module on a processor, one or more secondary asset data elements from the secondary asset dataset to one or more primary asset data elements from each of the fetched primary asset datasets; and
matching, by an asset tracking module on a processor, the secondary asset dataset to a primary asset dataset if the compared data elements correspond.

3. The method of claim 2 wherein the appropriate compared data elements comprise the vendor, and asset identifier.

4. The method of claim 3 wherein the appropriate compared data elements further comprise an asset description, asset deployment date and asset location.

5. The method of claim 4 wherein the processed asset datasets comprise the compared data elements and at least one other primary asset data element and at least one other secondary asset data element.

6. The method of claim 5 wherein the primary asset data elements contain at least one data element not found in any secondary asset data elements and each secondary asset data element contains at least one data element not found in the primary asset data elements.

7. The method of claim 6 wherein the primary asset data source comprises a contract management system and the one or more secondary asset data sources comprises an asset management system.

8. The method of claim 7 wherein the tracking further comprises:
receiving, by an asset tracking module on a processor, a request for processed asset datasets relating to a vendor;
querying, by an asset tracking module on a processor to the computer readable medium containing the database, the processed asset datasets relating to the vendor; and
providing, by an asset tracking module on a processor, the queried data results.

9. The method of claim 8 wherein the queried data results comprise the contracts with the vendor, the assets purchased from the vendor, and the total amount paid to the vendor.

10. A system for tracking assets within an enterprise, where data relating to such assets are stored and processed in disparate asset data sources, the system comprising:
an asset tracker comprising:
a processor;
a fetcher configured to communicate with one or more asset data sources and to receive one or more source data elements from each of the one or more asset data sources;
a database on a computer readable medium with one or more sink data elements of processed data; and
one or more data filters configured to receive the one or more source data elements from the fetcher, match the source data elements from the one or more asset data sources that relate to the same asset, process the related data into processed data and insert the processed data into the database.

11. The system of claim 10 further comprising:
an application server, configured to receive requests to view the processed data, query the database to retrieve the request processed data, and provide the requested processed data.

12. The system of claim 10 further comprising:
one or more data sources, each having asset data comprising one or more source data elements, configured to communicate with the fetcher.
